(19) United States
(12) Patent Application Publication
(10) Pub. No.: US 2018/0137507 A1
(43) Pub. Date: May 17, 2018

(54) PERFORMING VERIFICATION ON THE BLOCKCHAIN FOR NON-BLOCKCHAIN TRANSACTIONS

(71) Applicant: International Business Machines Corporation, Armonk, NY (US)

(72) Inventors: Praveen Jayachandran, Bangalore (IN); Palanivel Kodeswaran, Bangalore (IN); Sayandeep Sen, Bangalore (IN)

(21) Appl. No.: 15/350,932

(22) Filed: Nov. 14, 2016

(51) Int. Cl. G06Q 20/40; G06Q 20/06

(52) U.S. Cl. CPC G06Q 20/401; G06Q 20/065

(57) ABSTRACT

A blockchain configuration may be used to store a distributed ledger for information security and accessibility. One example method of operation may include one or more of receiving a request to obtain content from a buyer device, transmitting the request to a registered seller device associated with the content, receiving payment confirmation associated with the content on a blockchain, retrieving an encryption key associated with the content from the blockchain, transmitting the encryption key associated with the content to the buyer device, and based on the encryption key, transmitting the content outside the blockchain to the buyer device.

### TECHNICAL FIELD

This application relates to using a blockchain to provide verification, and more particularly, to performing verification on the blockchain for non-blockchain transactions.

### BACKGROUND

Information associated with a blockchain is typically related to financial transactions. As the popularity of blockchain continues to increase so does the desire to implement additional functionality using the blockchain. One limitation that currently exists is the inability to utilize the blockchain for non-blockchain transactions.

### SUMMARY

One example embodiment may include a method that comprises one or more of receiving a request to obtain content from a buyer device, transmitting the request to a seller device associated with the content, receiving payment confirmation associated with the content on a blockchain, retrieving an encryption key associated with the content from the blockchain, transmitting the encryption key associated with the content to the buyer device, and based on the encryption key transmitting the content outside the blockchain to the buyer device.

Another example embodiment may include an apparatus that comprises one or more of a receiver configured to receive a request from a buyer device to obtain content, a transmitter configured to transmit the request to a seller device associated with the content, and the receiver is also configured to receive payment confirmation associated with the content on a blockchain. The apparatus also includes a processor configured to retrieve an encryption key associated with the content from the blockchain, and the transmitter is further configured to transmit the encryption key associated with the content to the buyer device and based on the encryption key, and transmit the content outside the blockchain to the buyer device.

Yet another example embodiment may include a non-transitory computer readable storage medium configured to store instructions that when executed causes a processor to perform one or more of receiving a request from a buyer device to obtain content, transmitting the request to a seller device associated with the content, receiving payment confirmation associated with the content on a blockchain, retrieving an encryption key associated with the content from the blockchain, transmitting the encryption key associated with the content to the buyer device; and based on the encryption key, transmitting the content outside the blockchain to the buyer device.

### BRIEF DESCRIPTION OF THE DRAWINGS

FIG. 1 illustrates a logic diagram of a content sharing operation occurring outside a blockchain used for verification according to example embodiments.

FIG. 2 illustrates a system signaling diagram of a blockchain verification procedure for content shared outside the blockchain according to example embodiments.

FIG. 3A illustrates a flow diagram of an example method of verification and content exchange according to example embodiments.

FIG. 3B illustrates another flow diagram of another example method of verification and content exchange according to example embodiments.

FIG. 4 illustrates an example network entity configured to support one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

Example embodiments provide an application and/or software procedure which provides buyer and seller transaction management on a blockchain for content or other transactions (such as products bought/sold) off the blockchain network. As such, verification of transactions on the blockchain may be performed even for transactions that are not identified as being blockchain specific type transactions.

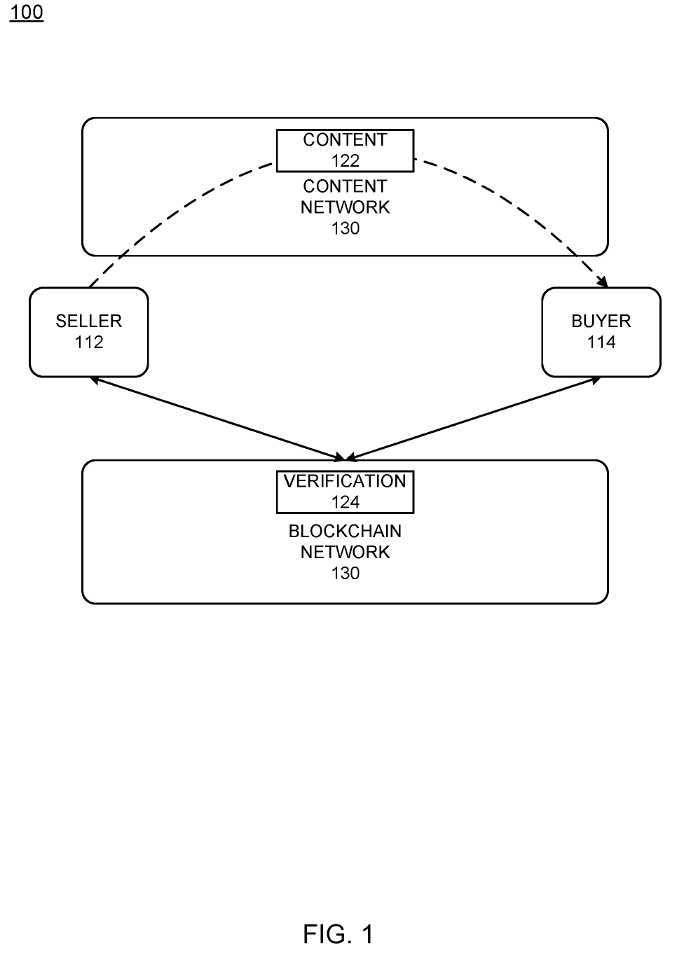

There are limitations as to what the blockchain configuration can store, for example, a large movie file of many megabytes or gigabytes which may violate blockchain file size limitations. For example purposes, the term ‘content’ refers to large file sizes of content which are being purchased by a buyer from a seller of such content. For example, in FIG. 1, the network 100 includes a content network 130 which may include one or more servers configured to store, retrieve and forward content managed and registered to a content owner/seller. The content may include any type of digital asset, such as movies, recorded programs, audio, text, data, etc.

In one example, a television series provider or official broadcaster of a concert may permit customers to view the series online and via a service, such as ‘on demand’. However, the content owners may not want to invest in additional infrastructure to handle the storage and delivery of the data to multiple customers across geographies. Alternatively, the provider stores one copy of the video on their computer storage system and permits others (e.g., sales partners) to act as secondary content providers (for an exchange fee, for example). In this context, the blockchain may ensure that any party can verifiably transact with others to execute an exchange (via, for example, a peer-to-peer exchange).

FIG. 1 illustrates a logic diagram of a content sharing operation occurring outside a blockchain used for verification according to example embodiments. Referring to FIG. 1, the network 100 includes a seller device 112, a buyer device 114 and two separate networks for supporting a content transaction between the two entities. The seller 112 may desire to sell content the buyer 114 is willing to purchase. The verification operations 124 may be sent to the blockchain 130 and stored for reference purposes. The content network 130 may support the storage and transfer of content 122 that is sent to the buyer once a purchase is made. A content provider is a party which can vouch for the authenticity of the digital content and which can redirect requests for buying to relevant sellers. A seller(s) is an entity which has a copy of the desired digital content and will transfer it to a buyer in various situations (for example, a fee is paid). A buyer(s) is an entity interested in acquiring data (for example, digital content) by paying the necessary fees.

Large video/audio files cannot be stored on the blockchain due to size restrictions. Ensuring verifiable and auditable peer-to-peer exchange of off-blockchain content may be performed in the blockchain. Example embodiments provide a method enabling verifiability and non-reputability of off-blockchain digital asset exchange in distributed settings using the blockchain for recording protocol operations. Example embodiments provide a method creating an audit trail of a peer-to-peer off-blockchain exchange by recording the sequence of transactions involved in the exchange on the blockchain. The system may permit buyers to check and disprove authenticity of contents received from third party sellers. The seller may receive payment confirmation for data storage and delivery service without having to create a specific trust agreement with the buyer. The buyer cannot deny payment or deny having received authentic content. The seller may study whether they are receiving their fair share of download requests. The buyer receives necessary content from an authenticated third party which may be delivered faster due to geographical proximity to a third party than to a content provider. The provider may operate a distributed content delivery network with minimal investment in network provisioning. A service fee can be charged for providing a validation and recommendation service on the blockchain. A higher return on investment provides cheaper capital investment and controls delivery of content.

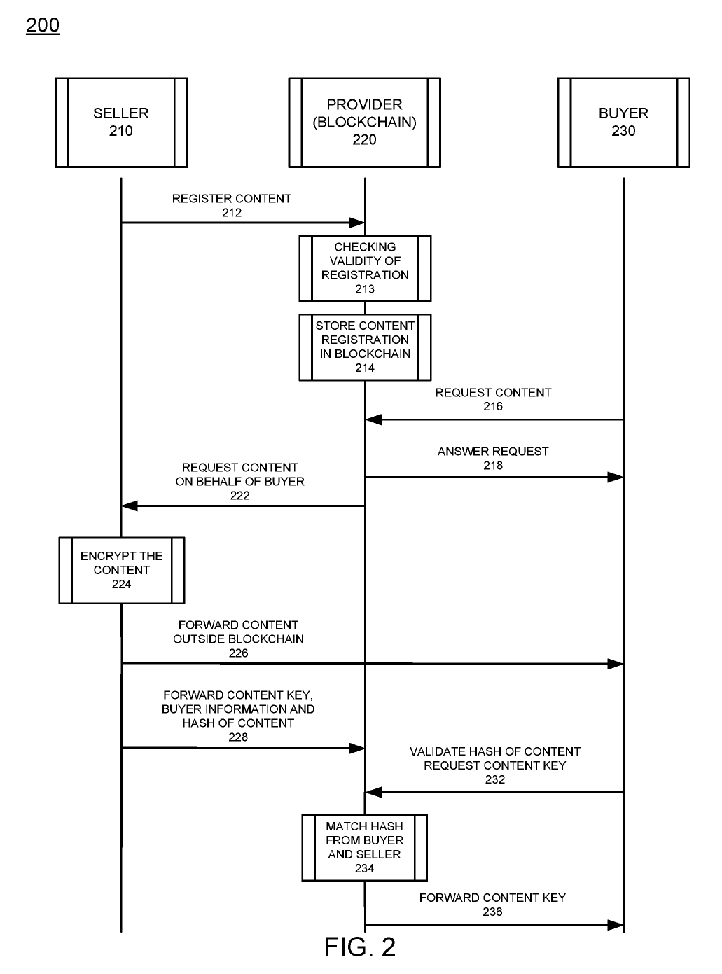

FIG. 2 illustrates a system signaling diagram of a blockchain verification procedure for content shared outside the blockchain according to example embodiments. Referring to FIG. 2, the system 200 includes a seller device 210, a blockchain 220 and a buyer device 230. A seller 210 may register content for sale 212 by registering availability of the content using a hash (for example, an SHA hash) and the relevancy of QoS information, such as location, availability, etc. The blockchain provider 220 may check the availability of the content by matching the hash and registering the content in a list 213. The content may be stored in the blockchain 214. Content may be requested 216 by the buyer 230 based on an identifier and payment may be submitted as well. The request can be answered 218 by sending seller information and checking the hash of the content to be expected by the buyer. The provider may then request the content from the seller 222. The seller may encrypt the content 224 with a new key unique to the transaction and send the encrypted content 226 and the hash of the encrypted content outside the blockchain 228. The buyer name and hash can be sent to the provider but not the content, which is sent outside the provider blockchain to the buyer. The buyer can validate the hash of the content request 232 by checking with the provider. The provider can compare the buyer hash with the known hash from the seller 234 and validate the encryption of the original content using a key and then send the key to the buyer once a final verification is performed. The buyer decrypts using the key and validates the original hash with the one supplied by the provider 236.

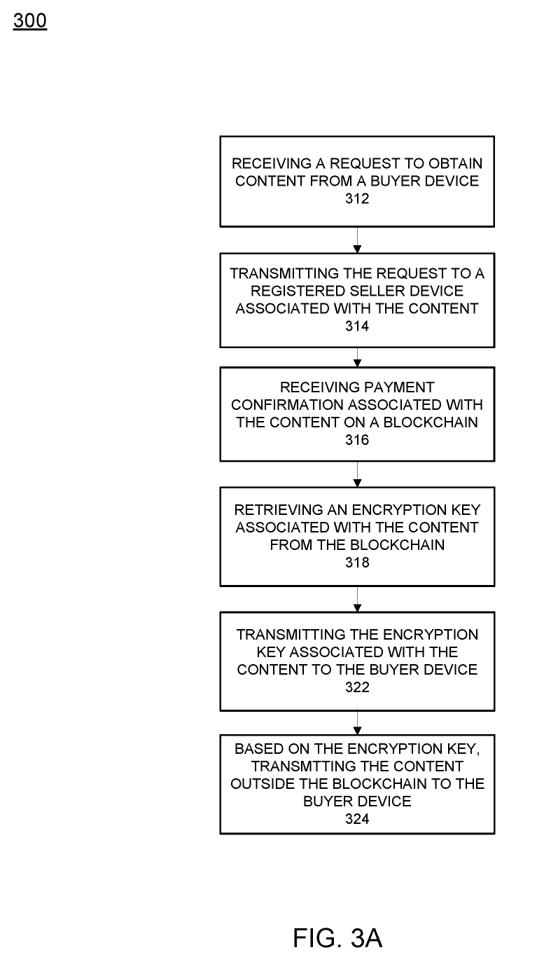

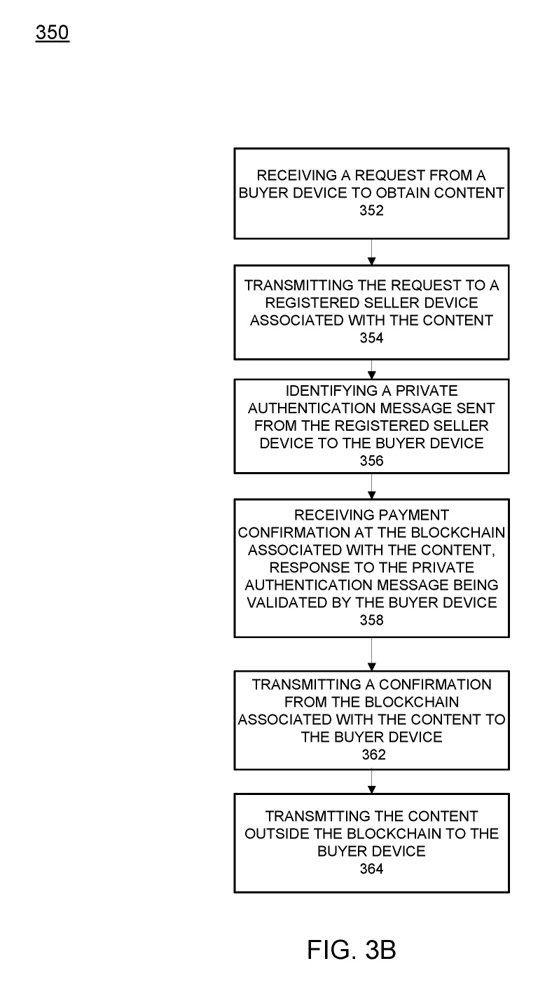

FIG. 3A illustrates a flow diagram 300 of an example method of verification and content exchange according to example embodiments. Referring to FIG. 3A, the method may include one or more of receiving a request from a buyer device to obtain content 312, transmitting the request to a registered seller device associated with the content 314, receiving payment confirmation associated with the content on a blockchain 316, retrieving an encryption key associated with the content from the blockchain 318, transmitting the encryption key associated with the content to the buyer device 322 and transmitting the content outside the blockchain to the buyer device 324.

FIG. 3B illustrates another flow diagram 350 of another example method of verification and content exchange according to example embodiments. Referring to FIG. 3B, the method may include one or more of receiving a request to obtain content from a buyer device at a blockchain 352, transmitting the request to a registered seller device associated with the content 354, identifying a private authentication message sent from the registered seller device to the buyer device 356, receiving payment confirmation at the blockchain associated with the content, responsive to the private authentication message being validated by the buyer device 358, transmitting a confirmation from the blockchain associated with the content to the buyer device 362, and transmitting the content outside the blockchain to the buyer device 364. In this example, the private authentication message may be sent and received outside the blockchain as a private e-mail, text message or other communication message which may include a link or another verification information source that verifies from the buyer/seller to the other party that the verification is valid and the parties are in fact who they claim to be, and thus the transaction may resume.

The method may also include registering the content on the blockchain via a registration received from the registered seller device. The content is registered with the encryption key associated with the content and the registration may include one or more of quality of service information, content location information and content availability information. The content location information is outside the blockchain. The content includes digital media having one or more of an audio file, a video file and a text file. The method also includes logging buyer information and the encryption key associated with the content in the blockchain and comparing the encryption key associated with the content with an encryption key associated with the seller, and responsive to matching the encryption key associated with the content and the encryption key associated with the registered seller device, forwarding the payment confirmation to the registered seller device.

When the seller registers content availability using a hash, the hash includes the digital content to be sold. The provider which has access to the same content then checks if the seller provided hash matches a hash the provider has with regard to a copy of the content. The provider checks the validity by matching the hash. The provider checks the hash of the content prior to authorizing the content to be shared to determine if they are the same hash. The seller encrypts the content with a new key and sends the encrypted content and the hash. The hash, based on the encrypted data, is separate from the key, and the key unlocks the encryption of the content. The seller sends the hash of encrypted content to the provider. The current hash (‘Hash2’) is the hash of the encrypted content while the previous hash (‘Hash1’) is a hash of the unencrypted content which was sent previously. The purpose of Hash1 is for the provider to ascertain that the seller indeed has the right content as the property of cryptographic hash calculation ensures that it will be costly computationally for the seller to guess the hash without having the content. The Hash2 ensures that when the buyer seeks to obtain the key to decrypt the content, the buyer has to give the hash of the encrypted content which the provider can match with Hash2 before providing the key to decrypt the content. This will ensure that at a later date the buyer cannot claim that the key/or encrypted file that the seller provided does not correspond to the actual content. The provider matches the hash received from the buyer with that of the seller prior to sending the key.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

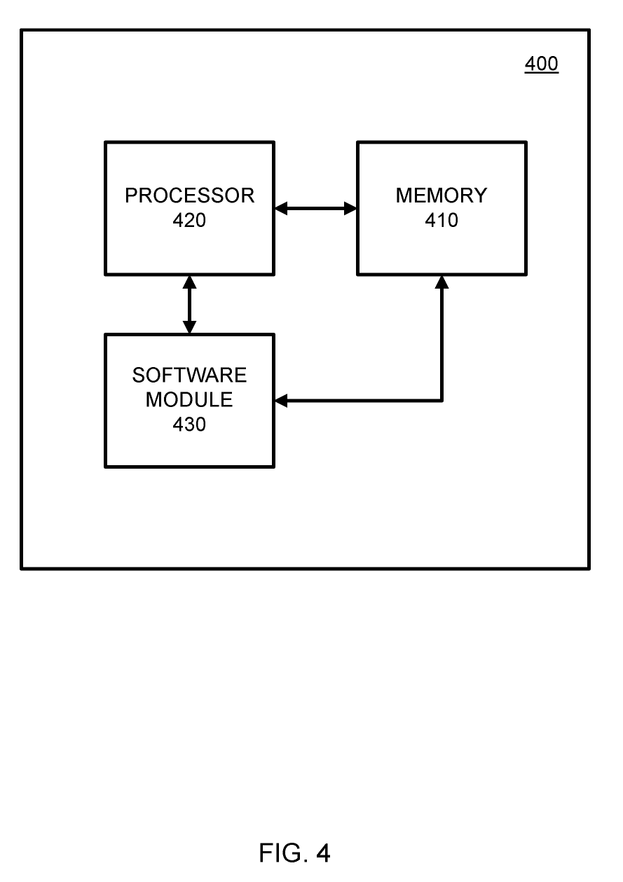

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 4 illustrates an example network element 400, which may represent or be integrated in any of the above-described components, etc.

As illustrated in FIG. 4, a memory 410 and a processor 420 may be discrete components of a network entity 400 that are used to execute an application or set of operations as described herein. The application may be coded in software in a computer language understood by the processor 420, and stored in a computer readable medium, such as, a memory 410. The computer readable medium may be a non-transitory computer readable medium that includes tangible hardware components, such as memory, that can store software. Furthermore, a software module 430 may be another discrete entity that is part of the network entity 400, and which contains software instructions that may be executed by the processor 420 to effectuate one or more of the functions described herein. In addition to the above noted components of the network entity 400, the network entity 400 may also have a transmitter and receiver pair configured to receive and transmit communication signals (not shown).

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
receiving a request from a buyer device to obtain content;
transmitting the request to a registered seller device associated with the content;
receiving payment confirmation associated with the content on a blockchain;
retrieving an encryption key associated with the content from the blockchain;
transmitting the encryption key associated with the content to the buyer device; and
based on the encryption key, transmitting the content outside the blockchain to the buyer device.

2. The method of claim 1, further comprising registering the content on the blockchain via a registration received from the seller device.

3. The method of claim 2, wherein the content is registered with the encryption key associated with the content and the registration comprises one or more of quality of service information, content location information and content availability information.

4. The method of claim 3, wherein the content location information is outside the blockchain.

5. The method of claim 1, wherein the content comprises digital media comprising one or more of an audio file and a video file.

6. The method of claim 1, further comprising logging buyer information and the encryption key associated with the content in the blockchain.

7. The method of claim 1, further comprising:
comparing the encryption key associated with the content with an encryption key associated with the seller device; and
responsive to matching the encryption key associated with the content and the encryption key associated with the registered seller device, forwarding the payment confirmation to the seller device.

8. An apparatus, comprising:
a receiver configured to:
receive a request from a buyer device to obtain content; and
receive payment confirmation associated with the content on a blockchain;
a transmitter configured to transmit the request to a seller device associated with the content; and
a processor configured to retrieve an encryption key associated with the content from the blockchain;
wherein the transmitter is further configured to transmit the encryption key associated with the content to the buyer device based on the encryption key and transmit the content outside the blockchain to the buyer device.

9. The apparatus of claim 8, wherein the processor is further configured to register the content on the blockchain via a registration received from the seller device.

10. The apparatus of claim 9, wherein the content is registered with the encryption key associated with the content and the registration comprises one or more of quality of service information, content location information and content availability information.

11. The apparatus of claim 10, wherein the content location information is outside the blockchain.

12. The apparatus of claim 8, wherein the content comprises digital media comprising one or more of an audio file and a video file.

13. The apparatus of claim 8, wherein the processor is further configured to log buyer information and the encryption key associated with the content in the blockchain.

14. The apparatus of claim 8, wherein the processor is further configured to:
compare the encryption key associated with the content with an encryption key associated with the seller; and
responsive to a match of the encryption key associated with the content and the encryption key associated with the seller device, forward the payment confirmation to the seller device.

15. A non-transitory computer readable storage medium configured to store instructions that when executed cause a processor to perform:
receiving a request from a buyer device to obtain content;
transmitting the request to a seller device associated with the content;
receiving payment confirmation associated with the content on a blockchain;
retrieving an encryption key associated with the content from the blockchain;
transmitting the encryption key associated with the content to the buyer device; and
based on the encryption key, transmitting the content outside the blockchain to the buyer device.

16. The non-transitory computer readable storage medium of claim 15, wherein the processor is further configured to perform registering the content on the blockchain via a registration received from the seller device.

17. The non-transitory computer readable storage medium of claim 16, wherein the content is registered with the encryption key associated with the content and the registration comprises one or more of quality of service information, content location information and content availability information.

18. The non-transitory computer readable storage medium of claim 17, wherein the content location information is outside the blockchain.

19. The non-transitory computer readable storage medium of claim 15, wherein the content comprises digital media comprising one or more of an audio file and a video file.

20. The non-transitory computer readable storage medium of claim 15, wherein the processor is further configured to perform:
logging buyer information and the encryption key associated with the content in the blockchain;
comparing the encryption key associated with the content with an encryption key associated with the seller; and
responsive to matching the encryption key associated with the content and the encryption key associated with the seller device, forwarding the payment confirmation to the seller device.
